(19) United States
(12) Patent Application Publication
(10) Pub. No.: US 2010/0132616 A1
(43) Pub. Date: Jun. 3, 2010

(54) Multi-finger spinner feeder and method of using same

(76) Inventor: Jamie Rieger, Kerrville, TX (US)

Correspondence Address: THE MATTHEWS FIRM, 2000 BERING DRIVE, SUITE 700, HOUSTON, TX, 77057, US

(21) Appl. No.: 12/315,245

(22) Filed: Dec. 1, 2008

(51) Int. Cl. A01K 5/00

(52) U.S. Cl. 119/57.91

(57) ABSTRACT

A multi-finger spinner having a plurality of fingers, each finger having a bend between the first and second ends. The multi-finger spinner is powered by a motor that spins the multi-finger spinner which distributes feed in a long and narrow area and in one direction. The spinner is installed within a feeder and below a hopper so that when feed falls from the hopper, the spinner will spin and distribute the feed.

### TECHNICAL FIELD

The embodiments relate generally to an apparatus and methods for dispensing feed to animals, including fish, wildlife or livestock. More specifically, the invention relates to dispersing feed in a rapid manner and in a long predictable pattern, preferably in a single direction.

### BRIEF DESCRIPTION OF DRAWINGS

FIG. 1 illustrates a top isometric view of an embodiment of the multi-finger spinner feeder according to the invention.

FIG. 2 illustrates a front, isometric view of the spinner of FIG. 1 mounted in a feeder according to the invention.

FIG. 3 illustrates a pictorial view demonstrating the calculation of the angles in the bend of the fingers.

FIG. 4 illustrates a front, isometric view of the motor and motor shaft mounted in an embodiment of the multi-finger spinner feeder, according to the invention.

### DETAILED DESCRIPTION OF EMBODIMENTS OF THE INVENTION

For a further understanding of the nature and objects of the present invention, reference should be had to the following detailed description, taken in conjunction with the accompanying drawings, in which like elements are given the same or analogous reference numbers.

It is well known in the art that a variety of different feeders and methods for dispersing the feed has been available for fish, wildlife and livestock, including but not limited to animals, birds, etc. The hoppers typically used in such feeders vary from closed containers or drums to uncovered or semi-covered troughs and a variety of other containers that provide access to the various animals, livestock or wildlife. Further, the dispersing of the feed from the hopper has also varied from the use of spinners with low voltage power sources such as batteries to more sophisticated controls such as photoelectric cells, which may turn on the feeder at daylight or after dark, as well as, more straightforward methods such as simple holes in the bottom of the hopper that allow the feed to fall by gravity or open troughs or other open areas, in which, as soon as the feed is eaten, more feed is drawn by gravity to replace it. However, the prior art does not provide for a rapid method to disperse the feed in a long, predictable pattern, preferably in a single direction.

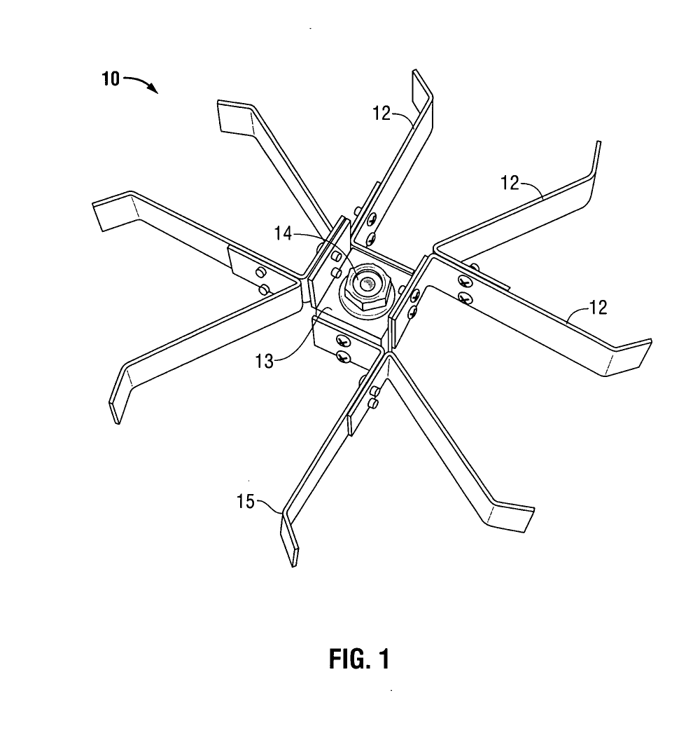

FIG. 1 illustrates an embodiment of the present invention. The spinner 10 has at least one finger 12. However, it should be appreciated that the number of fingers 12 is entirely dependent upon the preferred use of the spinner, how fast and in what pattern feed is to be dispersed. Preferably, the fingers 12 are made of galvanized steel or some other strong material such as, but not limited to, fiberglass, plastic, various composites, metals, or any combination thereof. Preferably, the fingers 12 have two ends. The first end of each such finger is attached, by welding or by other conventional connection device, for example, nuts and bolts, metal screws and the like, to a hub 13 and each of the fingers will have a bend 15. The bend 15 is preferably at an angle of about 50 degrees, but the fingers 12 may be bent at any preferred angle to accomplish the desired range of feed dispersion. The method used for attachment of the first end of the fingers 12 to the hub 13 may be, but is not limited to, the use of welding, bracing or through a series of bolts, rivets, screws and the like. The hub 13 is preferably fitted with a bushing 14, or some other device, designed to attach the hub 13 and fingers 12 to a motor shaft 34 (see FIG. 4) for spinning the multi-finger spinner 10.

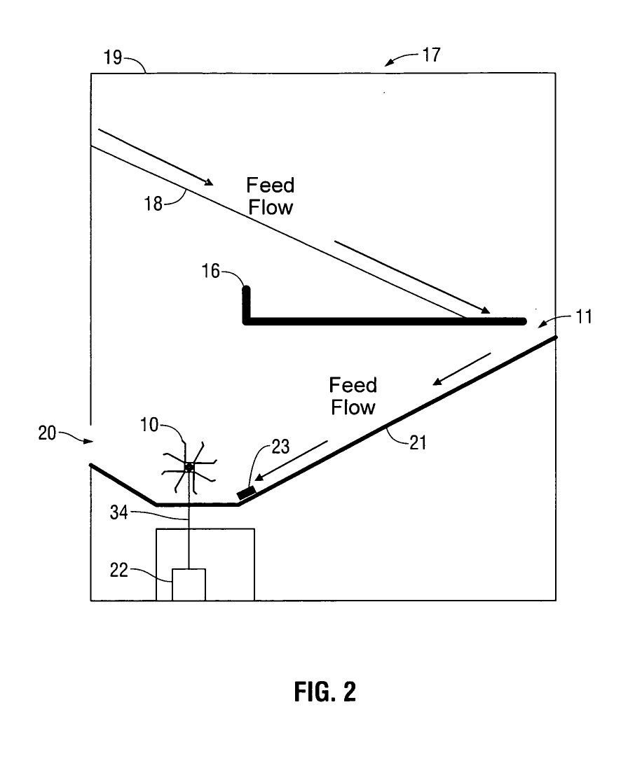

FIG. 2 represents an embodiment of a feeder 17 according to the invention within which the multi-finger spinner 10 is installed and operates to disperse feed. The multi-finger spinner 10 is preferably mounted within a feeder 17 and at the bottom of the feed flow ramp 18 so that when food falls from the hopper 19, it falls directly onto the spinner 10. The multi-finger spinner is mounted onto the motor shaft 34 of the motor 22 which is all contained, with the timer and battery, within a chamber under the spinner 10. The feeder also contains a retractable feed flow gate 16 which may be placed in a position that encourages optimum feed flow for the type of feed used. Preferably, the feeder 17 contains an orifice 11 which allows the feed to flow from the inclined feed funnel 18 to the feed flow ramp 21. The size of the orifice 11 is variable and depends on the type and size of feed used in the particular feeder. Feed travels down the feed flow ramp 21 to a small piece of steel called a feed flow stop 23 which restricts the feed flow to the spinner 10. The feed is then dispersed in a predetermined direction. While the hopper 19 portion of the feeder 17 is enclosed on all sides, there is a opening for feed dispersion 20 in the front of the feeder which the feed is pushed through in order to disperse in one predetermined direction.

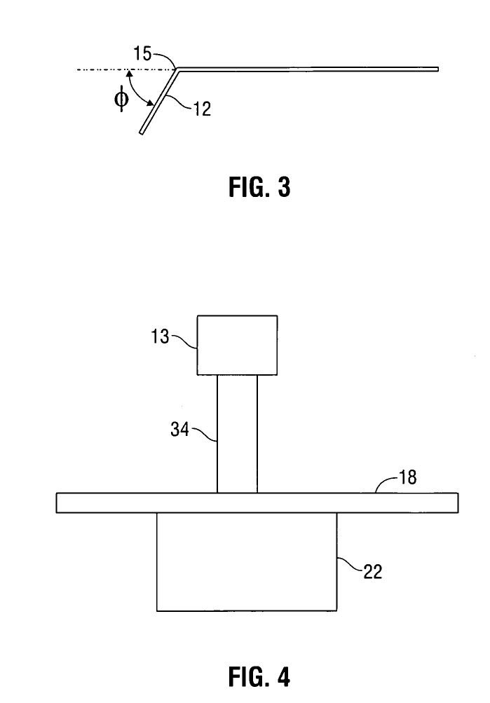

FIG. 3 represents how the angle of the bend 15 in each finger 12 is calculated in reference to the actual finger 12. When the angle φ of the bend 15 is described, for example as being 50 degrees, the angle referred to is the acute angle 31 illustrated by FIG. 3. The angle is preferably 90 degrees or less, but always greater than 0 degrees, and even more preferably between 35 degrees and 65 degrees.

FIG. 4 represents the connection from the motor 22 to the hub 13. The motor shaft 34 preferably passes through the feed flow ramp 21 and is fixedly mounted to the hub 13, which spins the spinner 10.

In operation, the hopper 19 is filled with feed. Feed falls down the inclined feed tunnel 18, through the orifice 11 and down the feed flow ramp 21 until it gets to the feed flow stop 23. The feed is dispersed when the spinner 10 begins to spin in response to the activation of the motor 22, which spins the motor shaft 34 attached to the bushing 14 and the hub 13. When the spinner 10 begins to rapidly spin, a suction is created which allows feed to flow freely past the feed flow stop 23 and onto the spinner 10 for dispersion. The portion of the feeder 17 adjacent to the spinner 10 is enclosed on all sides except for a large opening 20 on one side, which allows for the dispersion of feed in one direction. When the spinner 10 spins, the fingers 12 come in contract with the feed and rapidly disperse the feed in one direction.

The spinner 10 preferably spins in the counter-clockwise direction, and the fingers 12 preferably bend in the direction of the rotation of the spinner 10, as illustrated in FIG. 1. Using FIG. 1 as an example, the spinner 10 would rotate in the counter-clockwise direction and the fingers 12 are bent 15 in that same counter-clockwise direction.

While these embodiments have been described with emphasis on the embodiments, it should be understood that within the scope of the appended claims, the embodiments might be practiced other than as specifically described herein.

1. A spinner feeder for a feed dispensing apparatus comprising:
a feed flow ramp positioned within the interior of said feed dispensing apparatus, said feed flow ramp having an underside and a top side;
a motor fixedly connected to the underside of the feed flow ramp;
a rotating motor shaft being powered by said motor, wherein said motor shaft passes through said feed flow ramp;
a plurality of fingers, each finger having a first end and a second end, wherein each said finger has a bend; and wherein each said first end of said finger is fixedly fastened to said motor shaft;
wherein said motor causes said plurality of fingers to rotate and move feed from a tray positioned within an interior of said feed dispensing apparatus, wherein said feed is dispensed in only one direction to a predetermined feeding area.

2. The spinner feeder of claim 1, wherein said bend of each said finger is bent at an angle between 35 degrees and 65 degrees.

3. The spinner feeder of claim 1, wherein said bend of each said finger is bent at an angle of 50 degrees.

4. The spinner feeder of claim 1, wherein the number of said off-set fingers is between 4 and 12.

5. The spinner feeder of claim 1, wherein said bend of each said finger points in the counter-clockwise direction, and wherein said spinner spins in the counter-clockwise direction.

6. The spinner feeder of claim 1, wherein said bend of each said finger is in the clockwise direction, and wherein said spinner spins in the clockwise direction.

7. The spinner feeder of claim 1, further comprising a ledge fixedly attached to the feed dispensing apparatus for preventing feed from exiting the feed dispensing apparatus.

8. The spinner feeder of claim 1, wherein the rotating of said fingers creates a suction allowing feed to exit the feed dispensing apparatus.

9. A method for dispersing feed comprising:
providing a tray positioned within an interior of a feed dispensing apparatus, wherein said tray comprises an underside and a top side;
providing a motor fixedly connected to the underside of said tray;
providing a rotating motor shaft being powered by said motor, wherein said motor shaft passes through said tray;
providing a plurality of fingers fixedly connected to said motor shaft, each finger comprising a first end and a second end, wherein each said finger has a bend, and wherein each said first end of said finger is fastened to said motor shaft;
said motor causing said plurality of fingers to rotate;
said fingers moving feed from said tray and rapidly dispensing said feed in one direction to a predetermined feeding area.

10. The method of claim 9, wherein the bend in each of said fingers is an angle between 35 degrees and 65 degrees.

11. The method of claim 9, wherein the bend in each of said fingers is a 50 degree angle.

12. The method of claim 9, wherein the number of said fingers is between 4 and 12.

13. The method of claim 9, wherein said bend in each of said fingers points in the counter-clockwise direction, and wherein said spinner spins in the counter-clockwise direction.

14. The method of claim 9, wherein said bend in each of said fingers is in the clockwise direction, and wherein said spinner spins in the clockwise direction.

15. The method of claim 9, further providing a ledge fixedly attached to the feed dispensing apparatus for preventing feed from exiting the feed dispensing apparatus.

16. The method of claim 9, wherein the rotating of said fingers creates a suction allowing feed to exit the feed dispensing apparatus.
